(19) United States
(12) Patent Application Publication
(10) Pub. No.: US 2006/0248702 A1
(43) Pub. Date: Nov. 9, 2006

(54) Method and Means for Connecting Barbed Tubular Connectors

(76) Inventors: George Nikolaidis, Payneham South (AU); Manfred Imand Kurmis, Blackwood (AU)

Correspondence Address: AKERMAN SENTERFITT, P.O. BOX 3188, WEST PALM BEACH, FL, 33402-3188, US

(21) Appl. No.: 11/383,402

(22) Filed: May 15, 2006

Related U.S. Application Data
(63) Continuation-in-part of application No. 10/486,117, filed on Jul. 27, 2004.

(30) Foreign Application Priority Data
Aug. 6, 2001 (AU) PR6831
Dec. 7, 2001 (AU) PR9341
Feb. 26, 2002 (AU) PS0736

(51) Int. Cl. B23P 11/00; B21D 53/00; B26F 1/14

(52) U.S. Cl. 29/432; 83/684; 29/34 R

(57) ABSTRACT

A punch and insertion tool including an arm and a base that are integrally moulded so as to constitute a single, continuous piece of plastic material. The arm supports an insertion shaft with an outermost sharp end so that the insertion shaft extends approximately transversely to the arm, the insertion shaft having a diameter and shape such that it will pass fully through the bore of a barbed tubular connector. The base includes means to hold a plastic tubing in a position opposing the insertion shaft so that the arm and the base can be pressed together in such a fashion that the arm will impinge any barbed tubular connector positioned on the shaft and push it with the shaft into an installed position in the wall of the plastic tubing tube.

### CROSS REFERENCE TO RELATED APPLICATIONS

This application is a continuation-in-part of U.S. patent application Ser. No. 10/486,117, filed Feb. 6, 2004, which was a §371 national phase of PCT/AU02/01038, filed Aug. 6, 2002. The entire contents of these earlier applications are incorporated herein by reference.

### TECHNICAL FIELD

The present invention relates to a method and means for effecting a connection of a barbed tubular connector in the wall of plastic tubing.

### BACKGROUND ART

It is known to use thin wall plastic tubing for the transmission of water for irrigation purposes, and to connect at spaced apart locations, barbed tubular connectors that are inserted through pierced apertures in the wall of the tubing.

The current method of installing such connectors is to first pierce the wall with a punch and then separately get a tubular barbed connector and push this through the wall to an extent where an end of the barb is passed through a periphery of the pierced hole.

This technique is found to be arduous when a number of connectors have to be installed and an object of this invention is to provide both a means and a method which allows the installation method to be less arduous than has hitherto been the case or, at the least, there is provided to the public a useful alternative.

It was envisaged then that a tool providing a shaft with an outermost sharp end having a diameter and shape such that it would pass fully through the bore of a barbed tubular connector, and means at an inner end of such a shaft whereby to impinge any tubular connector positioned on the shaft so as to enable such a position connector to be pushed with the shaft into an installed position in the wall of a tube, would greatly simplify the process of inserting these barbed tubular connectors into the wall of tubing.

U.S. Pat. No. 6,381,821 in the name of Panyon (which is not admitted to be common general knowledge) discloses an ‘emitter barb installation tool’ that utilizes the aforementioned principle. The tools disclosed in Panyon however are very complex, comprising many parts. They would therefore be expensive to manufacture and prone to malfunction.

It is a further object of the invention then to provide a tool that is simpler, and therefore less expensive to produce, than the tools of the prior art.

### DISCLOSURE OF THE INVENTION

In one form of the invention there is proposed a punch and insertion tool including an arm and a base that are integrally moulded so as to constitute a single, continuous piece of plastic material, the arm supporting an insertion shaft with an outermost sharp end so that the insertion shaft extends approximately transversely to the arm, the insertion shaft having a diameter and shape such that it will pass fully through the bore of a barbed tubular connector, the base having means to hold a plastic tubing in a position opposing the insertion shaft so that the arm and the base can be pressed together in such a fashion that the arm will impinge any barbed tubular connector positioned on the shaft and push it with the shaft into an installed position in the wall of the plastic tubing tube.

Preferably, the insertion shaft is made from a steel material, and it is moulded into the arm.

Preferably, the insertion shaft is of such a length that when a barbed tubular connector is disposed thereon, the outermost sharp end of the insertion shaft extends from the end of the barbed tubular connector.

Preferably, there is a U-shaped turning point in the material between the arm and the base.

Preferably, the means to hold the plastic tubing includes an open U-shaped nest, which is integrally moulded into the base and into which the plastic tubing can be squeezed and held thereby.

Preferably, the U-shaped nest squeezes the sides of plastic tubing held therein closer together.

Preferably, the arm is adapted to be moved between a first position relative to the base in which the insertion shaft is clear of any plastic tube retained by the means to hold the plastic tubing, and a second position relative to the base in which the insertion shaft will pierce the plastic tubing and install a tubular barbed connector disposed thereon in the wall of the plastic tubing tube.

Preferably, pressure must be applied to the arm and base in order to move them into the second position relative to one another.

Preferably, when the pressure is removed from them, the arm and the base will return to the first position relative to one another.

Preferably, there is also connected to the arm, a blade adapted to be positioned in at least one of two positions, one of which is a stored position, and another of which is an operating position, the operating position being such that when the arm is brought together with the base, the blade is adapted to cut through any plastic tubing that might be being held relative to the base.

In a further form, the invention may be said to reside in a method of using the punch and insertion tool, including the steps of disposing a barbed tubular connector upon the insertion shaft, placing the plastic tubing in the means for holding said tubing, and pressing the arm and the base together in such a fashion that the arm will impinge upon the barbed tubular connector positioned on the shaft and push it with the shaft into an installed position in the wall of the plastic tubing.

Preferably, the method includes the further step of releasing the arm and the base so that these move apart, thereby withdrawing the shaft from the tubular bathed connector.

### BRIEF DESCRIPTION OF THE DRAWINGS

For a better understanding of this invention it will now be described with respect to the preferred embodiment which shall be described herein with the assistance of drawings wherein;

FIG. 1 is a perspective view of the punch and insertion tool; and

FIGS. 2 and 3 are cross-sectional views through a barbed connector that is disposed upon the shaft of the punch and insertion tool in FIG. 1.

### BEST MODE FOR CARRYING OUT THE INVENTION

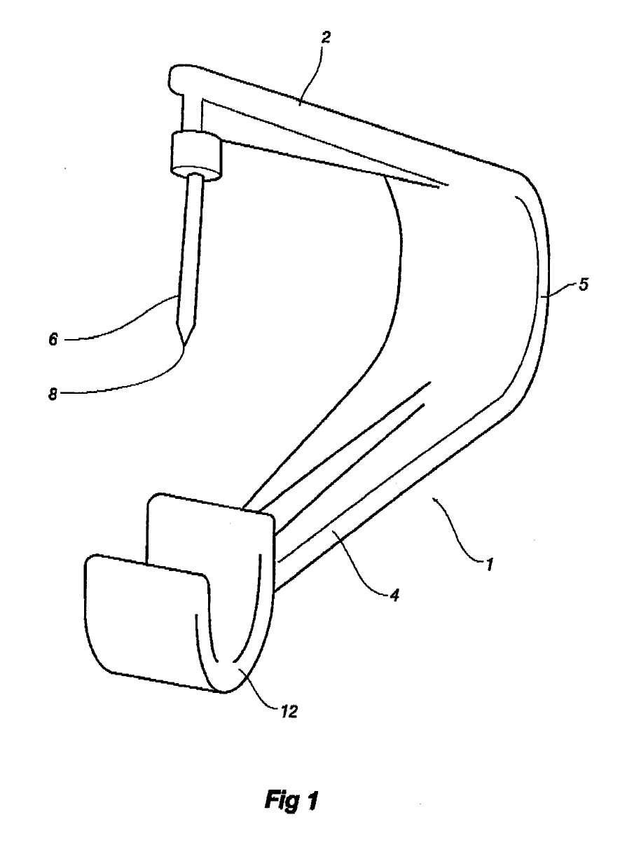

Now referring in detail to the illustrations, and in particular to FIG. 1, where there is illustrated a punch and insertion tool 1 that has been integrally moulded from a plastic material via injection moulding.

The punch includes an upper arm 2 and a lower base 4 integrally connected by a U-shaped portion 5. A stainless-steel shaft 6, with an outermost sharp end 8, is integrally moulded with the arm 2 so as to project approximately transversely to this. This shaft 6 is of slightly lesser diameter than the internal diameter of a bore of a barbed tubular connector 10.

At the outer end of the base 4 there is an integrally formed U-shaped portion 12 which is adapted to laterally hold a plastic tubing 14 so that the otherwise circular cross-sectional shape of the tubing 14 will be squeezed, first of all thereby providing better resistance to piercing of the sharp point 8 of the shaft 6 and also to hold firmly the tubing 14 in position with respect to the shaft 6.

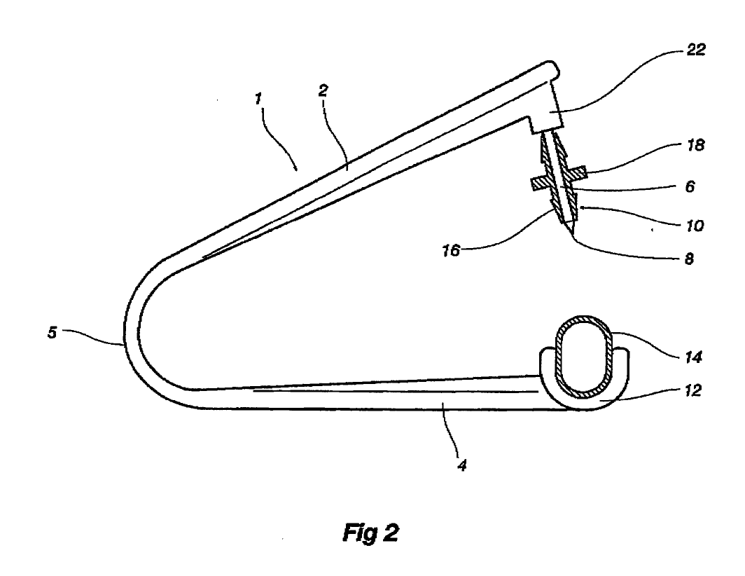

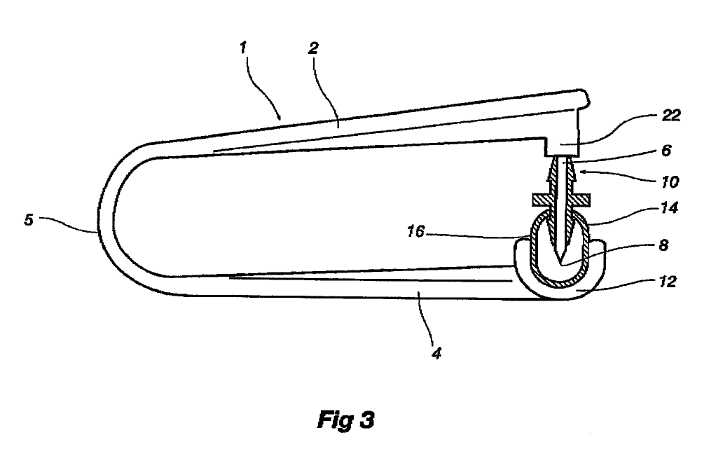

The arm 2 is adapted to be moved between a first position relative to the base 4 in which the insertion shaft 6 is clear of any plastic tube 14 retained in the U-shaped portion 12 of the base 4 (see FIG. 2), and a second position relative to the base 4 in which the insertion shaft 6 will pierce the plastic tubing 14 and install a tubular barbed connector 10 disposed thereon in the wall of the plastic tubing 14 (see FIG. 3).

Pressure must be applied to the arm 2 and base 4 in order to move them into the second position relative to one another.

When this pressure is removed, the arm 2 and the base 4 will return to the first position relative to one another, due in part to both the geometry (the tool is thickest at the U-shaped turning point 5) of the tool 1 and the nature of the plastic material from which it is formed.

In use, the barbed tubular connector 10 is disposed upon the shaft 6 such that the sharp end 8 of the shaft 6 only just extends from the bore of the barbed connector 10. Then with one pushing action the outermost sharp end 8 of the shaft 6 can pierce a hole through the wall of the plastic tubing 14, and then immediately follow the creation of this hole with the insertion of barbed connector 10. The hole size then is minimized and the hole is left with a clean edge. As a result, a very good seal is achieved between the hole in the tube 14 and the outside of the barbed tubular connector 10.

The tubular connector 10 has barbs 16 at each end in conventional manner so that once they have passed through the hole in the wall of the tubing 14 they will effect a water sealing engagement therewith.

The barb 16 of the barbed connector 10 is forced though the hole made by the insertion shaft 6 by virtue of boss 22 of arm 2 impinging upon it and driving through the hole into the tubing 14.

It is considered that a method and means for effecting a connection of a barbed tubular connector in the wall of plastic tubing according to the present invention, will be quick and therefore inexpensive to produce, and light, robust, reliable and easy to use.

Although the invention has been herein shown and described in what is conceived to be the most practical and preferred embodiment, it is recognized that departures can be made within the scope of the invention, which is not to be limited to the details described herein but is to be accorded the fall scope of the appended claims so as to embrace any and all equivalent devices and apparatus.

1. A punch and insertion tool including an arm, and a base that are integrally moulded so as to constitute a single, continuous piece of plastic material, the arm supporting an insertion shaft with an outermost sharp end so that the insertion shaft extends approximately transversely to the arm, the insertion shaft having a diameter and shape such that it will pass fully through the bore of a barbed tubular connector, the base having means to hold a plastic tubing in a position opposing the insertion shaft so that the arm and the base can be pressed together in such a fashion that the arm will impinge any barbed tubular connector positioned on the shaft and push it with the shaft into an installed position in the wall of the plastic tubing tube.

2. The punch and insertion tool of claim 1, wherein the insertion shaft is made from a steel material, and it is moulded into the arm.

3. The punch and insertion tool of claim 1, wherein the insertion shaft is of such a length that when a barbed tubular connector is disposed thereon, the outermost sharp end of the insertion shaft extends from the end of the barbed tubular connector.

4. The punch and insertion tool of claim 1, wherein there is a U-shaped turning point in the material between the arm and the base.

5. The punch and insertion tool of claim 1, wherein the means to hold the plastic tubing includes an open U-shaped nest which is integrally moulded into the base and into which the plastic tubing can be squeezed and held thereby.

6. The punch and insertion tool of claim 5, wherein the U-shaped nest squeezes the sides of plastic tubing held therein closer together.

7. The punch and insertion tool of claim 1, wherein the arm is adapted to be moved between a first position relative to the base in which the insertion shaft is clear of any plastic tube retained by the means to hold the plastic tubing, and a second position relative to the base in which the insertion shaft will pierce the plastic tubing and install a tubular barbed connector disposed thereon in the wall of the plastic tubing tube.

8. The punch and insertion tool as in claim 7, wherein pressure must be applied to the arm and base in order to move them into the second position relative to one another.

9. The punch and insertion tool as in claim 8, wherein when the pressure is removed, the arm and the base will return to the first position relative to one another.

10. A method of using the punch and insertion tool of claim 1, including the steps of disposing a barbed tubular connector upon the insertion shaft, placing the plastic tubing in the means for holding said tubing, and pressing the arm and the base together in such a fashion that the arm will impinge upon the barbed tubular connector positioned on the shaft and push it with the shaft into an installed position in the wall of the plastic tubing.

11. The method of claim 10, including the further step of releasing the arm and the base so that these move apart, thereby withdrawing the shaft from the tubular barbed connector.
